(19) United States
(12) Patent Application Publication
(10) Pub. No.: US 2024/0326396 A1
(43) Pub. Date: Oct. 3, 2024

(54) Edge Strip and Method of Producing an Edge Strip

(71) Applicant: Fritz Egger GmbH & Co. OG

(72) Inventors: Thomas Streichardt, Warendorf (DE); Peter Florian Schwermer, Kirchhundem (DE)

(21) Appl. No.: 18/290,801

(22) PCT Filed: Jul. 22, 2022
(86) PCT No.: PCT/EP2022/070649

§ 371 Date: May 8, 2024

(30) Foreign Application Priority Data
Jul. 23, 2021 (EP) 21187477.1

(51) Int. Cl. B32B 27/32; B32B 7/12; B32B 27/06; B32B 27/20

(52) U.S. Cl. CPC B32B 27/327; B32B 7/12; B32B 27/06; B32B 27/20; B32B 2250/02; B32B 2307/72; B32B 2307/7376; B32B 2479/00

(57) ABSTRACT

What is presented and described is an edge strip comprising a structure layer and at least one function layer, bonded to the structure layer, for securing the edge strip on a narrow face of a workpiece wherein the function layer contains a polypropylene homopolymer and a polyethylene homopolymer, as is a method of producing the edge strip, comprising a. forming, especially extruding, the at least one function layer containing the polypropylene homopolymer and the polyethylene copolymer, b. forming the structure layer, and c. bonding the function layer to the structure layer. Also described is a method of securing an edge strip on a workpiece, the use of a function layer described herein as meltable putty in strip form, and to a meltable putty in strip form and to a workpiece comprising an edge strip.

### TECHNICAL FIELD OF THE INVENTION

The invention relates to an edge strip, in particular for pieces of furniture, comprising a structural layer and at least one functional layer for fastening the edge strip to a narrow side of a workpiece, in particular a piece of furniture. The invention further relates to a method for producing edge strips, the use of a functional layer described herein as a band-shaped hot-melt cement, a workpiece, in particular a piece of furniture, comprising an edge strip according to the invention, and a strip-shaped hot-melt cement.

### TECHNICAL BACKGROUND OF THE INVENTION

Edge strips for covering the narrow surfaces of open panels, in particular fronts, countertops, carcasses, shelves, and side-panel shelving systems, are known. PVC, ABS, PP or PMMA plastics, for example, are used as material for the edges. Typical wall thicknesses of such edge strips are 0.4 to 3 mm. The edge strips are normally adhesively bonded to the narrow sides of the panels.

The edge strips are often thermoplastic edge strips.

The edge strips can be adhesively bonded to the panels in various ways. Adhesively bonding the edge strips to the panels, especially to the narrow side of the panels, by means of a hot-melt adhesive is known in the prior art. In this case, the edge strip is adhesively bonded to the narrow side of the panel over the entire surface.

In order to reduce the complexity in the application and in the devices for attaching the edge strips, edge strips which already comprise a hot-melt layer are also known in the prior art. The hot-melt layer can also be referred to as a functional layer. The presence of the hot-melt layer allows the edge strip to be welded to the panels, for example by means of laser technique, hot air or other techniques.

Various edge strips have been developed to control the adhesion of the edge strip on the panel.

DE 20 2007 011 911 U1 describes, for example, an edge strip comprising a hot-melt layer, wherein the hot-melt layer contains both polar and nonpolar constituents in the molecular structure. An important material for the hot-melt layer of DE 20 2007 011 911 U1 is a graft copolymer, in particular maleic-anhydride-grafted polypropylene. However, the edge strips of DE 20 2007 011 911 U1 are disadvantageous, since the graft copolymers to be used cause high costs, and corner connections at which the welding is performed edge to edge are often weaker. In addition, such edges can be attached only with increased complexity and/or within a small processing window to polypropylene panels, which are used, for example, for furniture for outdoor kitchens or for patient transport furniture.

In contrast, the hot-melt layer of WO 2015/097163 A1 is mainly composed of an easy-flowing polyolefin, the easy-flowing polyolefin being constructed only of nonpolar monomers. However, the edge strips of WO 2015/097163 A1 are not equally well suited for all substrates and exhibit significantly lower pull-off forces from chipboard panels than from MDF panels after fastening. Furthermore, in WO 2015/097163 A1 polypropylene homopolymers are used alone or together with polypropylene copolymers. However, polypropylene homopolymers are normally brittle, and therefore the resulting edge strips with polypropylene homopolymers in the hot-melt layer, when being attached to the panel, often break during approach and generate much scrap. The high brittleness also presents problems already during the production of the edge strips, especially during the rolling up and the cutting of the produced edge strips. In addition, the brittleness makes it difficult to attach the edge strips to round panels. The use of polypropylene copolymers is costly, on the other hand. In addition, the use of polypropylene copolymers results the formulation design possibilities in.

DE 10 2014 109750 A1 describes an edge strip for covering narrow surfaces of panel-type workpieces, the edge strip having a main layer and a hot-melt layer for fastening the edge strip to the workpiece.

DE 20 2014 106173 U1 describes an edge strip comprising a hot-melt layer and a layer connected to the hot-melt layer, the hot-melt layer containing admixtures.

EP 3 114 186 B1 describes an adhesive composition comprising: a base polymer comprising an ethylene-vinyl-acetate-containing polymer; a tackifier; an adhesion promoter comprising at least one semi-crystalline polymer having an average molecular weight of 30 kg/mol or less; an antioxidant; and an optional wax.

U.S. Pat. No. 3,418,396 A describes a polyolefin composition for extrusion, coating and molding various articles, comprising a predominant portion of a mixture of from 40 wt. % to 99 wt. % of a polypropylene having a flow rate of from about 12 dg/min to 120 dg/min and about 1 wt. % to 60 wt. % of a polyethylene having a melt index of from about 1 dg/min to 15 dg/min, a density greater than 0.912 g/cm³, and a melt index recovery of greater than 50%.

US 2009/142610 A1 describes a hotmelt adhesive composition comprising at least one thermoplastic polyolefin being solid at 25° C. and at least one amide of the formula (I) or (II).

It was an object of the invention to provide an edge strip which at least partially overcomes the disadvantages of the prior art. In particular, the edge strips should have good processability and good strength after attachment to a workpiece. Further objects, features, and advantages of the present invention are clear from the following description.

### SUMMARY OF THE INVENTION

This object is achieved by an edge strip, in particular for pieces of furniture, comprising a structural layer and at least one functional layer for fastening the edge strip to a narrow side of a workpiece, in particular a piece of furniture, said functional layer being connected to the structural layer, wherein the functional layer contains a polypropylene homopolymer and a polyethylene homopolymer, the polypropylene homopolymer having a melt flow index of 150 g/10 min or more, measured at 230° C. with a weight of 2.16 kg according to DIN EN ISO 1133-1, in particular DIN EN ISO 1133-1:2021-03.

The invention also relates to a method for producing an edge strip, in particular for pieces of furniture, comprising a structural layer and at least one functional layer for fastening the edge strip to a narrow side of a workpiece, in particular a piece of furniture, said functional layer being connected to the structural layer and containing a polypropylene homopolymer and a polyethylene homopolymer, and said method comprising
a. forming, in particular extruding, the at least one functional layer containing the polypropylene homopolymer and the polyethylene homopolymer,
b. forming, in particular extruding, the structural layer, and
c. connecting the functional layer to the structural layer, wherein the polypropylene homopolymer has a melt flow index of 150 g/10 min or more, measured at 230° C. with a weight of 2.16 kg according to DIN EN ISO 1133-1, in particular DIN EN ISO 1133-1:2021-03.

The invention also relates to a method for fastening an edge strip according to the invention to the narrow side of a workpiece, in particular a piece of furniture, wherein the functional layer is activated by the effect of at least one of laser radiation, microwave radiation, ultrasound, infrared radiation, plasma and hot air.

The invention also relates to the use of a functional layer as defined herein as a band-shaped hot-melt cement, in particular in the fastening of a strip or a band to a narrow side of a workpiece, in particular a piece of furniture.

The invention also relates to a workpiece, in particular a piece of furniture, comprising an edge strip according to the invention.

Finally, the invention relates to a band-shaped hot-melt cement for fastening a strip or a band to a narrow side of a workpiece, in particular a piece of furniture, wherein the hot-melt cement contains a polypropylene homopolymer and a polyethylene homopolymer, the polypropylene homopolymer having a melt flow index of 150 g/10 min or more, measured at 230° C. with a weight of 2.16 kg according to DIN EN ISO 1133-1, in particular DIN EN ISO 1133-1:2021-03.

By using a polypropylene homopolymer in conjunction with a polyethylene homopolymer in the functional layer according to the invention in the edge strip, it is easily possible to adapt the functional layer to the adhesive-bonding substrate in question, for example chipboard panels or MDF panels. Good adhesive bonding of the edge strip to the substrate in question can thereby be established. Furthermore, the edge strips according to the invention have good flexibility, so that scrap in the production of, for example, the edge strips, but also of furniture panels, can be reduced. Furthermore, it has been found that, by using polypropylene homopolymer and polyethylene homopolymer in the functional layer, the so-called “open time”, i.e., the time for attaching the edge strip to the workpiece after activation of the functional layer, can be extended, whereby the processing, in particular in the case of adhesive bonding over a curved surface, can be simplified. It has also been found that edge strips with a functional layer containing polypropylene homopolymer and polyethylene homopolymer enable a large processing window in the attachment process, in particular with regard to the energy input. Finally, polypropylene homopolymers and polyethylene homopolymers can be recycled well.

### PREFERRED EMBODIMENTS OF THE INVENTION

A cement, in particular a hot-melt cement, serves to connect materials. A hot-melt cement is solid at room temperature, melts without loss of substance when heated and solidifies without substantial shrinkage when cooled. A hot-melt cement becomes plastic and thus processable only by melting.

The melt flow indices specified herein are preferably determined according to DIN EN ISO 1133-1:2012-03.

The polypropylene homopolymer can have various melt flow indices. The flowability of the functional layer can be controlled by means of the melt flow index. The polypropylene homopolymer has a melt flow index of 150 g/10 min or more, preferably 200 g/10 min or more, measured at 230° C. with a weight of 2.16 kg according to DIN EN ISO 1133-1, in particular DIN EN ISO 1133-1:2021-03. It has been found that, in the case of lower melt flow indices, the edge strip has a lower peel strength after attachment to the panel. It is thought that, due to a lower melt flow index, the functional layer cannot penetrate into the pore structure of the substrate so effectively, which can lead to lower peel strengths.

Furthermore, the polypropylene homopolymer preferably has a melt flow index of 1200 g/10 min or less, preferably 900 g/10 min or less, more preferably 700 g/10 min or less, particularly preferably 500 g/10 min or less, measured at 230° C. with a weight of 2.16 kg according to DIN EN ISO 1133-1, in particular DIN EN ISO 1133-1:2021-03. It has been found that, in the case of higher melt flow indices, the functional layer, after activation or heat-up, can be too liquid for application to a panel.

Suitable polypropylene homopolymers can be obtained, for example, from Idemitsu Chemicals, Borealis AG or other manufacturers of polypropylene homopolymers.

The polyethylene homopolymer can have various melt flow indices. The polyethylene homopolymer preferably has a melt flow index of 200 g/10 min or less, preferably 150 g/10 min or less, more preferably 130 g/10 min or less, even more preferably 100 g/10 min or less, particularly preferably 70 g/10 min or less, measured at 190° C. with a weight of 2.16 kg according to DIN EN ISO 1133-1, in particular DIN EN ISO 1133-1:2021-03. With a polyethylene homopolymer having a melt flow index in the above ranges, the functional layer can be well adapted to the corresponding substrates.

Furthermore, the polyethylene homopolymer preferably has a melt flow index of 0.1 to 300 g/10 min, preferably 0.1 to 200 g/10 min, more preferably 0.1 to 130 g/10 min, even more preferably 0.1 to 100 g/10 min, particularly preferably 0.1 to 70 g/10 min, measured at 190° C. with a weight of 2.16 kg according to DIN EN ISO 1133-1, in particular DIN EN ISO 1133-1:2021-03.

The melt flow index of the polyethylene homopolymer can be selected in particular according to the machines used for mixing and/or according to the melt flow indices of the other components. For example, the polyethylene homopolymer can have a melt flow index of 0.1 to 20 g/10 min, in particular 0.1 to 10 g/10 min, measured at 190° C. with a weight of 2.16 kg according to DIN EN ISO 1133-1, in particular DIN EN ISO 1133-1:2021-03. The polyethylene homopolymer can also have, for example, a melt flow index of 25 to 300 g/10 min, in particular 30 to 130 g/10 min, measured at 190° C. with a weight of 2.16 kg according to DIN EN ISO 1133-1, in particular DIN EN ISO 1133-1:2021-03.

Various types of polyethylene homopolymers are known to a person skilled in the art. For example, low-density polyethylene homopolymers (PE-LDs) and linear low-density polyethylene homopolymers (PE-LLDs) are known to a person skilled in the art. Furthermore, metallocene polyethylene homopolymers are known to a person skilled in the art. In particular, PE-LLDs can be metallocene polyethylene homopolymers. Accordingly, for the production of the polyethylene homopolymer in the at least one functional layer, the monomers customary for the production of PE-LLD can also be used.

Various polyethylene homopolymers are possible for the functional layer according to the invention. Preferably, the polyethylene homopolymer is a PE-LD, preferably a PE-LLD. The polyethylene homopolymer also preferably has a density of 0.900 g/cm³ to 0.940 g/cm³, preferably 0.910 g/cm³ to 0.936 g/cm³. According to one embodiment, the polyethylene homopolymer is a metallocene polyethylene homopolymer.

The functional layer can also contain further polyethylene homopolymers.

Suitable polyethylene homopolymers can be obtained, for example, from LyondellBasell, Chevron Phillips Chemical Company LP or other manufacturers of polyethylene homopolymers.

With the aforementioned polypropylene homopolymers and polyethylene homopolymers, the strength of the fastening to the workpiece can be adjusted and/or improved.

The term “polypropylene homopolymer” is preferably understood to mean polypropylene homopolymer which is not grafted, in particular polypropylene homopolymer which is not grafted with silanes. The term “polyethylene homopolymer” is preferably understood to mean polyethylene homopolymer which is not grafted, in particular polyethylene homopolymer which is not grafted with silanes.

The functional layer can have different thicknesses. The functional layer advantageously has a thickness of 0.05 mm to 5 mm, preferably 0.05 mm to 2 mm, more preferably 0.05 mm to 1 mm, particularly preferably 0.1 mm to 0.25 mm.

The edge strip expediently has a width of 5 mm to 120 mm, preferably 5 to 80 mm, more preferably 5 to 40 mm, even more preferably 5 to 30 mm, particularly preferably 18 to 28 mm.

The polypropylene homopolymer can be present in different amounts in the functional layer. The functional layer preferably contains 40 wt. % to 99 wt. %, preferably 55 wt. % to 95 wt. %, more preferably 70 wt. % to 95 wt. %, particularly preferably 80 wt. % to 95 wt. %, of the polypropylene homopolymer, relative to the total mass of the functional layer.

Furthermore, the functional layer can contain different amounts of polyethylene homopolymer. The functional layer preferably contains 0.1 wt. % to 40 wt. %, preferably 0.1 wt. % to 30 wt. %, more preferably 0.1 to 25 wt. %, even more preferably 1 wt. % to 20 wt. %, particularly preferably 1 wt. % to 10 wt. %, of the polyethylene homopolymer, relative to the total mass of the functional layer.

According to one embodiment, the functional layer can contain at least one filler. The functional layer can contain natural-fiber-based fillers or mineral fillers. Examples of natural-fiber-based fillers are wood fibers, hemp fibers, bamboo fibers, sisal fibers, rice husks or coconut fibers. Examples of mineral fillers are talc, barium sulfate, calcium carbonate, dolomite, silicon dioxide, mica, kaolin, diatomaceous earth, glass, wollastonite, calcium sulfate, halloysite or zinc oxide.

The functional layer preferably contains at least one filler selected from the group consisting of natural-fiber-based fillers, in particular wood fibers, hemp fibers, bamboo fibers, sisal fibers, rice husks or coconut fibers, mineral fillers, in particular talc, barium sulfate, calcium carbonate, dolomite, silicon dioxide, mica, kaolin, diatomaceous earth, glass, wollastonite, calcium sulfate, halloysite or zinc oxide, and mixtures thereof.

It has been found that the hardness of the functional layer can be increased by adding fillers to the functional layer. An increase in hardness leads to improved milling behavior when protrusions of the edge strip are milled off after the edge strip has been attached to a workpiece. The entry of dirt into a functional layer during later use can also be reduced by increasing the hardness. In addition, the flow behavior of the functional layer can be influenced by the addition of fillers. Finally, it has been found that fillers in the functional layer enable faster production of the edge strip and faster attachment of the edge strip to a workpiece. Without desire to be bound by a scientific theory, this appears to be caused by a nucleating effect of the fillers which causes faster curing of the functional layer.

The functional layer can contain fillers in different amounts. The functional layer preferably contains at least one filler in an amount of 1 wt. % to 40 wt. %, preferably 1 wt. % to 35 wt. %, more preferably 1 wt. % to 25 wt. %, particularly preferably 1 wt. % to 10 wt. %, relative to the total mass of the functional layer.

According to one embodiment, the edge strip contains 1 wt. % to 40 wt. %, preferably 1 wt. % to 35 wt. %, more preferably 1 wt. % to 25 wt. %, particularly preferably 1 wt. % to 10 wt. %, of at least one filler selected from the group consisting of natural-fiber-based fillers, in particular wood fibers, hemp fibers, bamboo fibers, sisal fibers, rice husks or coconut fibers, mineral fillers, in particular talc, barium sulfate, calcium carbonate, dolomite, silicon dioxide, mica, kaolin, diatomaceous earth, glass, wollastonite, calcium sulfate, halloysite or zinc oxide, and mixtures thereof.

Furthermore, the functional layer can contain one or more additives. Properties of the functional layer and thus of the edge strip can be influenced in a targeted manner with additives. The functional layer can in particular contain an additive selected from the group consisting of antioxidants, UV absorbers, hindered amine light stabilizers (HALSs), pigments, dyes, anti-slip agents, antiblocking agents, light stabilizers, and mixtures thereof.

Antioxidants can be obtained, for example, from MPI Chemie, BASF SE, Clariant AG or other manufacturers for plastics additives. Antioxidants can increase the heat stability of the functional layer.

UV absorbers can be obtained, for example, from MPI Chemie, BASF SE, Solvay SA or other manufacturers of UV absorbers. UV absorbers help increase the UV stability of the functional layer.

Pigments and dyes can be obtained, for example, from BASF SE, Altana AG, Merck KGaA, Clariant AG or other manufacturers of pigments and dyes. The pigments and dyes can be present in different forms. The pigments and/or dyes preferably can be dissolved or dispersed in the polypropylene homopolymer and/or in the polyethylene homopolymer. The pigments and/or dyes preferably are dissolved or dispersed in the polypropylene homopolymer and/or in the polyethylene homopolymer.

Anti-slip agents can be obtained, for example, from Kafrit Industries Ltd, A. Schulman Inc., Ampacet Corporation or other manufacturers of anti-slip agents. Anti-slip agents can help increase the production speed.

Antiblocking agents can be obtained, for example, from Kafrit Industries Ltd, Ampacet Corporation, Croda International plc or other manufacturers of antiblocking agents. Antiblocking agents can help prevent undesired adhesion of the edge strip, in particular of a rolled-up edge strip.

Hindered amine light stabilizers (HALSs) can be obtained, for example, from BASF SE, Clariant AG, Azelis SA or other manufacturers of HALSs. HALSs can improve the light stability of the functional layer. This can also slow or reduce aging and in particular embrittlement of the functional layer in the processed state.

The functional layer can contain the additives in various amounts. The total amount of additives in the functional layer is advantageously 0.1 wt. % to 15 wt. %, preferably 0.1 wt. % to 10 wt. %, relative to the total mass of the functional layer. In particular, the additives can individually each be contained in the functional layer in an amount of 0.1 wt. % to 5 wt. %, preferably 0.1 wt. % to 3 wt. %, relative to the total mass of the functional layer. Additives which are not pigments or dyes can particularly preferably be contained in the functional layer in an amount of 0.1 wt. % to 1 wt. %, relative to the total mass of the functional layer.

The functional layer advantageously contains energy-absorbing admixtures. Energy-absorbing admixtures can activate the functional layer, whereby the fastening of the edge strip to a workpiece, in particular a piece of furniture, is improved.

Different energy-absorbing admixtures can be used, depending on the type of energy used when fastening the edge strip to a workpiece. Examples of energy-absorbing admixtures are heat-absorbing admixtures, radiation-absorbing admixtures such as microwave-radiation-absorbing admixtures, and light-absorbing admixtures. The functional layer preferably contains light- and/or radiation-absorbing admixtures. The functional layer more preferably contains laser-absorbing admixtures. Laser-absorbing admixtures are useful in particular when the edge strip is fastened by means of laser activation.

Energy-absorbing admixtures are advantageously contained in the edge strip in an amount of 0.1 wt. % to 5 wt. %, preferably 0.1 wt. % to 3 wt. %, more preferably 0.1 wt. % to 1 wt. %, relative to the total mass of the functional layer.

The polypropylene homopolymer, the polyethylene homopolymer, the filler, the additives and the energy-absorbing admixtures can be referred to as constituents of the functional layer. All constituents of the functional layer preferably add up to 100 wt. %, relative to the total weight of the functional layer.

The edge strip comprises at least one functional layer. The edge strip can also comprise two or more functional layers. If the edge strip comprises two or more functional layers, the functional layers can be the same or different. Two or more functional layers can be arranged in different ways. For example, two functional layers can be arranged one on top of the other, so that only one of the functional layers comes into direct contact with the workpiece. In this way, the one functional layer can be optimized for the adhesion of the edge strip to the workpiece, while the other functional layer can fulfill other purposes. Two functional layers can also be arranged side by side. This can be advantageous, for example, in order to adapt the edge strip to inhomogeneous workpieces. Three or more functional layers can be arranged one on top of the other, side by side, or in combinations thereof. Three functional layers side by side can be advantageous, for example, for lightweight panels or honeycomb panels. If three functional layers are used side by side, they can also have different thicknesses. For example, the middle functional layer can be thicker than the outer functional layers. The outer functional layers can also be thicker than the middle functional layer.

The edge strip can also comprise exactly one functional layer.

The structural layer of the edge strip, to which the functional layer is connected, can improve the mechanical stability of the edge strip. The structural layer can also give the edge strip a decorative effect.

The structural layer can be directly connected to the functional layer. The edge strip can then be produced by means of coextrusion, for example. The functional layer is preferably connected to the structural layer by coextrusion. This type of connection is advantageous in particular for production in high quantities.

The functional layer can also be applied to the structural layer in an additional step after the production of the structural layer. This allows the production process to be flexibly designed. The functional layer can be connected to the structural layer by post-coating, post-coextrusion, lamination or hot coating.

The structural layer can also be indirectly connected to the functional layer. For example, an adhesive layer or an adhesion promoter layer can be between the structural layer and the functional layer. An adhesion promoter layer is preferably arranged between the functional layer and the structural layer.

The structural layer can be made of various materials. The structural layer is preferably made of a material which contains paper, cardboard, veneer, continuous pressure laminate (CPL) or a thermoplastic material. Continuous pressure laminates are sometimes also referred to as melamine edges and can be obtained, for example, from specialist dealers.

The structural layer is furthermore preferably made of a material which contains a thermoplastic material, in particular a thermoplastic polymer. The thermoplastic polymer can be a thermoplastic polymer made from fossil raw materials or from bio-based substances or a thermoplastic material made from fossil raw materials and bio-based substances, such as a thermoplastic copolymer or a composite material. The thermoplastic material preferably can be extruded. The thermoplastic material advantageously has a melting point below 400° C. The thermoplastic polymer is preferably selected from the group consisting of wood-plastic composite, polyethylene, polyethylene made from bio-based substances, polypropylene, polypropylene made from bio-based substances, polylactic acid, starch, thermoplastic starch, acrylonitrile-butadiene-styrene copolymer, acrylonitrile-styrene-acrylate copolymer, polyvinyl chloride, polymethyl methacrylate, polyethylene terephthalate, olefin-based thermoplastic elastomer, thermoplastic polyurethane, thermoplastic copolyester, styrene block copolymers such as styrene-butadiene-styrene copolymer, styrene-ethylene-butylene-styrene copolymer, styrene-ethylene-propylene-styrene copolymer, styrene-ethylene-ethylene-propylene-styrene copolymer, poly(methyl methacrylate-co-butadiene-co-styrene), thermoplastic copolyamide and mixtures thereof. The aforementioned materials are commonly used in the production of edge strips and are commercially available. Polymers made from bio-based resources or substances are, for example, polymers made from renewable raw materials, such as polyethylene produced from sugarcane-based ethanol.

The method according to the invention for producing an edge strip, in particular for pieces of furniture, comprising a structural layer and at least one functional layer for fastening the edge strip to a narrow side of a workpiece, in particular a piece of furniture, said functional layer being connected to the structural layer and containing a polypropylene homopolymer and a polyethylene homopolymer, comprises
a. forming, in particular extruding, the at least one functional layer containing the polypropylene homopolymer and the polyethylene homopolymer,
b. forming, in particular extruding, the structural layer, and
c. connecting the functional layer to the structural layer, wherein the polypropylene homopolymer has a melt flow index of 150 g/10 min or more, measured at 230° C. with a weight of 2.16 kg according to DIN EN ISO 1133-1, in particular DIN EN ISO 1133-1:2021-03.

The polypropylene homopolymer and the polyethylene homopolymer can be present together in a masterbatch, or they can be supplied separately to the extruder.

The statements above regarding the functional layer of the edge strip according to the invention, in particular regarding the polypropylene homopolymer, the polyethylene homopolymer, the thickness, the filler, the additives and the energy-absorbing admixtures, preferably apply accordingly to the functional layer of the production method according to the invention. The statements above regarding the structural layer of the edge strip according to the invention, in particular regarding the material, preferably apply accordingly to the structural layer of the production method according to the invention.

In particular, an edge strip according to the invention can be produced using the method according to the invention.

In the production method according to the invention, the functional layer is expediently coextruded with the structural layer. A direct connection of the functional layer to the structural layer can thereby be achieved. Alternatively, in the production method according to the invention the functional layer can also be applied to a structural layer, in particular a prefabricated structural layer. In particular, the functional layer can be connected to the structural layer by post-coating, post-coextrusion, lamination or hot coating.

According to one embodiment, the functional layer is connected to a prefabricated structural layer by post-coating, post-coextrusion, lamination or hot coating, in particular in an additional step after production of the structural layer. An adhesion promoter layer can be applied to the structural layer in this embodiment, and the functional layer is thereafter applied to the adhesion promoter layer on the structural layer, in particular by post-coating. Likewise, in this embodiment an adhesion promoter layer can be applied to the functional layer, and the structural layer is thereafter applied to the adhesion promoter layer on the functional layer, in particular by post-coating.

According to another embodiment, the structural layer and the functional layer are prefabricated. In this embodiment, the prefabricated structural layer and the prefabricated functional layer can be connected to one another by lamination. In this embodiment, an adhesion promoter layer can be applied to the structural layer and/or to the functional layer.

The adhesion promoter layer can be applied to the structural layer and/or to the functional layer in particular by coextrusion, extrusion, preferably post-coextrusion, or by application of an adhesion-promoter-containing liquid.

During the production of the edge strip, it is possible to produce a plurality of edge strips simultaneously. In this case, a band having a width of 10 mm to 800 mm, preferably 10 mm to 500 mm, particularly preferably 20 mm to 420 mm, is first produced in a first step, and the band is subsequently cut into edge strips having the aforementioned widths.

In the method according to the invention for fastening an edge strip according to the invention to the narrow side of a workpiece, in particular a piece of furniture, the functional layer is activated by the effect of at least one of laser radiation, microwave radiation, ultrasound, infrared radiation, plasma and hot air.

If laser radiation is used to activate the functional layer, the energy density of the laser radiation can be 5 J/cm² to 50 J/cm², preferably 10 J/cm² to 30 J/cm², preferably 15 J/cm² to 25 J/cm². The laser power can depend in particular on the color of the functional layer. A lower laser power is required for functional layers with a dark color.

When the functional layer is activated by means of hot air, the hot air is preferably provided at a temperature of 300° C. to 650° C. Preferably, the hot air is provided at a pressure of 2 bar to 6 bar.

If a machine is used to fasten the edge strip to the narrow side of a workpiece, the machine preferably uses an advancement rate of 3 m/min to 80 m/min, in particular 3 m/min to 30 m/min, in particular 10 m/min to 20 m/min, work.

In the use according to the invention, a functional layer as described above is used as a band-shaped hot-melt cement, preferably in the fastening of a strip or a band to a narrow side of a workpiece. The workpiece can in particular be a piece of furniture or a furniture panel.

The strip, which is preferably fastened to a narrow side of a workpiece in the use according to the invention, is preferably a strip made of a material as described above for the structural layer. The band, which is preferably fastened to a narrow side of a workpiece in the use according to the invention, is preferably a band made of a material as described above for the structural layer. The statements above regarding the structural layer preferably apply accordingly to the strip and/or the band of the use according to the invention.

In the use according to the invention, the functional layer is used similarly to a double-sided adhesive tape which is activated to develop the adhesive effect. In the use according to the invention, the band-shaped hot-melt cement can consist of one or more functional layers described above, for example two, three or four functional layers. Preferably, the band-shaped hot-melt cement consists of exactly one functional layer described above. The statements above regarding the functional layer for the edge strip according to the invention, in particular regarding the polypropylene homopolymer, the polyethylene homopolymer, the thickness, the filler, the additives and the energy-absorbing admixtures, preferably apply accordingly to the band-shaped hot-melt cement of the use.

The workpiece, in particular piece of furniture, according to the invention comprises an edge strip according to the invention. The edge strip can have been attached to the workpiece in a method according to the invention for fastening an edge strip according to the invention to the narrow side of a workpiece.

The invention also relates to a band-shaped hot-melt cement for fastening a strip or a band to a narrow side of a workpiece, in particular a piece of furniture, wherein the hot-melt cement contains a polypropylene homopolymer and a polyethylene homopolymer, the polypropylene homopolymer having a melt flow index of 150 g/10 min or more, measured at 230° C. with a weight of 2.16 kg according to DIN EN ISO 1133-1, in particular DIN EN ISO 1133-1:2021-03.

The statements made above regarding the strip and the band in respect of the use according to the invention preferably apply accordingly to the strip and the band of the band-shaped hot-melt cement according to the invention. The statements above regarding the functional layer of the edge strip according to the invention, in particular regarding the polypropylene homopolymer, the polyethylene homopolymer, the thickness, the filler, the additives and the energy-absorbing admixtures, preferably apply accordingly to the band-shaped hot-melt cement according to the invention.

### EXAMPLES

### Materials

PPH: Polypropylene homopolymer having a melting temperature (DSC) of 158° C. according to ISO 11357-3 and a melt flow index according to ISO 1133-1 of 1200 g/10 min at 230° C. with a weight of 2.16 kg.
PE1: Low-density polyethylene (LDPE) having a melting temperature of 180 to 230° C., a density of 0.918 g/cm³ according to ISO 1183-1, a Shore D hardness of 45 according to ISO 868 and a melt flow index according to ISO 1133-1 of 65 g/10 min at 190° C. with a weight of 2.16 kg.
PE2: Metallocene linear low-density polyethylene (m-LLDPE) having a density of 0.918 g/cm³ according to ASTM D1505 and a melt flow index according to ASTM D1238 of 1 g/10 min at 190° C. with a weight of 2.16 kg.
FS Black dye.

### Methods

Edge strips with a functional layer dyed black and a structural layer having a width of 23 mm were produced by coextrusion. The structural layer with a thickness of 2 mm was produced from acrylonitrile butadiene styrene. The functional layer had a thickness of 0.2 mm. The composition of the various functional layers is listed in Table 1 below.

TABLE 1
Produced edge strip with a structural layer made of acrylonitrile
butadiene styrene. The amounts of the constituents of
the functional layer are each in wt. %

Amount of the constituent in the
functional layer of edge strip no.

| Const.^{a} | 1^{b} | 2 | 3 | 4 | 5 | 6 |
|---|---|---|---|---|---|---|
| PPH | 99 | 94.5 | 84.5 | 79.5 | 89.5 | 79.5 |
| PE1 | 0 | 4.5 | 14.5 | 19.5 | 0 | 0 |
| PE2 | 0 | 0 | 0 | 0 | 9.5 | 19.5 |
| FS | 1 | 1 | 1 | 1 | 1 | 1 |

Explanations regarding Table 1:
^{a}Const.—Constituent;
^{b}Comparative example.

Edge strips 1 to 6 were fastened to MDF panels and to chipboard panels with a thickness of 18 mm by means of laser activation. The edge strips were pneumatically pressed, with the activated functional layer, onto the narrow side of the MDF panels and chipboard panels with a machine pressure of 2 bar and at an advancement rate of 18 m/min. The laser activation was carried out with the energy densities indicated in Tables 2 and 3. A Homag PROFI KAL330/9/A3/L (2013) was used for attaching the edge strip to the panels.

The average peel strengths of edge strips 1 to 6 are compiled in Tables 2 and 3 below.

In all edge strips mounted to the panels, the edge strip protruded beyond the narrow side. The protrusion was removed by machining, so that the panels were connected to the edge strip with no step.

TABLE 2
Peel strength, in N/mm, of the edge strips attached
to chipboard panels, in the case of activation of the
functional layer with different energy densities.

| Energy | Chipboard panel peel strength [N/mm]^{a} for edge | | | | | |
|---|---|---|---|---|---|---|
| density | strip no. according to the energy density | | | | | |
| [J/cm²]^{c} | 1^{d} | 2 | 3 | 4 | 5 | 6 |
| 14 | nd^{b} | 1.8 | nd^{b} | nd^{b} | nd^{b} | 1.5 |
| 16 | nd^{b} | 2.7 | 2.2 | 2.3 | 2.3 | 2.2 |
| 18 | nd^{b} | 3.0 | 2.6 | 2.1 | 3.1 | 2.4 |
| 20 | nd^{b} | 3.3 | 2.5 | 2.1 | 2.6 | 2.9 |
| 22 | 2.5 | 3.1 | 2.6 | 2.3 | 2.9 | 2.7 |
| 24 | 2.6 | 2.9 | 2.8 | 2.2 | 2.5 | 2.4 |
| 26 | 2.9 | 3.1 | 2.5 | 2.1 | 3.1 | 2.9 |
| 28 | nd^{b} | 2.8 | 2.7 | 1.9 | 2.4 | 2.4 |

Explanations regarding Table 2:
^{a}Peel strength determined according to DIN EN 1464: 2010-06;
^{b}ND—Not determined;
^{c}Energy density used when activating the edge strip;
^{d}Comparative example.

TABLE 3
Peel strength, in N/mm, of the edge strips attached
to MDF panels, in the case of activation of the
functional layer with different energy densities.

| Energy | | | | | | |
|---|---|---|---|---|---|---|
| density | MDF panel peel strength [N/mm]^{a} for edge strip no. | | | | | |
| [J/cm²]^{c} | 1^{d} | 2 | 3 | 4 | 5 | 6 |
| 14 | nd^{b} | 4.7 | nd^{b} | nd^{b} | 3.2 | 4.2 |
| 16 | 2.8 | 5.1 | 5.9 | 5.3 | 5.3 | 5.9 |
| 18 | 3.6 | 5.9 | 5.0 | 3.7 | 5.8 | 5.3 |
| 20 | nd^{b} | 5.2 | 3.3 | 3.8 | 5.2 | 3.6 |
| 22 | nd^{b} | 4.6 | 2.9 | 4.0 | 4.4 | 3.3 |
| 24 | nd^{b} | 4.3 | 2.8 | 3.3 | 4.3 | 3.7 |
| 26 | nd^{b} | 6.8 | 3.3 | 4.9 | 4.3 | 2.2 |
| 28 | nd^{b} | 5.7 | 4.8 | 6.3 | 3.3 | 1.7 |

Explanations regarding Table 3:
^{a}Peel strength determined according to DIN EN 1464: 2010-06;
^{b}nd—Not determined;
^{c}Energy density used when activating the edge strip;
^{d}Comparative example.

It can be seen from Tables 2 and 3 that an edge strip having a functional layer containing polypropylene homopolymer and polyethylene homopolymer has, on chipboard panels, at least comparable peel strengths or even higher peel strengths and, at the same time on MDF panels, has higher peel strengths than an edge strip having a functional layer containing only polypropylene homopolymer. In addition, Tables 2 and 3 show that high peel strengths were obtained for edge strips 2 to 6 over many different energy densities for activating the functional layer. Edge strips 2 to 6 therefore have large processing windows in the attaching of the edge strips to a piece of furniture.

1. Edge strip, in particular for pieces of furniture, comprising a structural layer and at least one functional layer for fastening the edge strip to a narrow side of a workpiece, in particular a piece of furniture, said functional layer being connected to the structural layer, characterized in that the functional layer contains a polypropylene homopolymer and a polyethylene homopolymer, the polypropylene homopolymer having a melt flow index of 150 g/10 min or more, measured at 230° C. with a weight of 2.16 kg according to DIN EN ISO 1133-1, in particular DIN EN ISO 1133-1:2021-03.

2. Edge strip according to claim 1, characterized in that the polypropylene homopolymer has a melt flow index of 200 g/10 min or more, measured at 230° C. with a weight of 2.16 kg according to DIN EN ISO 1133-1, in particular DIN EN ISO 1133-1:2021-03.

3. Edge strip according to any one of the preceding claims, characterized in that the polypropylene homopolymer has a melt flow index of 1200 g/10 min or less, preferably 900 g/10 min or less, more preferably 700 g/10 min or less, particularly preferably 500 g/10 min or less, measured at 230° C. with a weight of 2.16 kg according to DIN EN ISO 1133-1, in particular DIN EN ISO 1133-1:2021-03.

4. Edge strip according to any one of the preceding claims, characterized in that the polyethylene homopolymer has a melt flow index of 200 g/10 min or less, preferably 150 g/10 min or less, more preferably 130 g/10 min or less, even more preferably 100 g/10 min or less, particularly preferably 70 g/10 min or less, measured at 190° C. with a weight of 2.16 kg according to DIN EN ISO 1133-1, in particular DIN EN ISO 1133-1:2021-03.

5. Edge strip according to any one of the preceding claims, characterized in that the polyethylene homopolymer is a PE-LD, preferably a PE-LLD, and/or has a density of 0.900 g/cm³ to 0.940 g/cm³, preferably 0.910 g/cm³ to 0.936 g/cm³, and/or is a metallocene polyethylene homopolymer.

6. Edge strip according to any one of the preceding claims, characterized in that the functional layer has a thickness of 0.05 mm to 5 mm, preferably 0.05 mm to 2 mm, more preferably 0.05 mm to 1 mm, particularly preferably 0.1 mm to 0.25 mm.

7. Edge strip according to any one of the preceding claims, characterized in that the functional layer contains 40 wt. % to 99 wt. %, preferably 55 wt. % to 95 wt. %, more preferably 70 wt. % to 95 wt. %, particularly preferably 80 wt. % to 95 wt. %, of the polypropylene homopolymer, relative to the total mass of the functional layer.

8. Edge strip according to any one of the preceding claims, characterized in that the functional layer contains 0.1 wt. % to 40 wt. %, preferably 0.1 wt. % to 30 wt. %, more preferably 0.1 to 25 wt. %, even more preferably 1 wt. % to 20 wt. %, particularly preferably 1 wt. % to 10 wt. %, of the polyethylene homopolymer, relative to the total mass of the functional layer.

9. Edge strip according to any one of the preceding claims, characterized in that the functional layer contains at least one filler.

10. Edge strip according to any one of the preceding claims, characterized in that the functional layer contains at least one filler selected from the group consisting of natural-fiber-based fillers, in particular wood fibers, hemp fibers, bamboo fibers, sisal fibers, rice husks or coconut fibers, mineral fillers, in particular talc, barium sulfate, calcium carbonate, dolomite, silicon dioxide, mica, kaolin, diatomaceous earth, glass, wollastonite, calcium sulfate, halloysite or zinc oxide, and mixtures thereof, in particular in an amount of 1 wt. % to 40 wt. %, preferably 1 wt. % to 35 wt. %, more preferably 1 wt. % to 25 wt. %, particularly preferably 1 wt. % to 10 wt. %, relative to the total mass of the functional layer.

11. Edge strip according to any one of the preceding claims, characterized in that the functional layer contains an additive selected from the group consisting of antioxidants, UV absorbers, in particular hindered amine light stabilizers (HALSs), pigments, dyes, anti-slip agents, antiblocking agents, light stabilizers and mixtures thereof.

12. Edge strip according to any one of the preceding claims, characterized in that the functional layer contains energy-absorbing admixtures, preferably light-and/or radiation-absorbing admixtures, more preferably laser-absorbing admixtures.

13. Edge strip according to any one of the preceding claims, characterized in that the structural layer is made of a material which contains paper, cardboard, veneer, continuous pressure laminate (CPL) or a thermoplastic material, preferably of a material which contains a thermoplastic material, more preferably a thermoplastic polymer, particularly preferably a thermoplastic polymer selected from the group consisting of wood-plastic composite, polyethylene, polyethylene made from bio-based substances, polypropylene, polypropylene made from bio-based substances, polylactic acid, starch, thermoplastic starch, acrylonitrile-butadiene-styrene copolymer, acrylonitrile-styrene-acrylate copolymer, polyvinyl chloride, polymethyl methacrylate, polyethylene terephthalate, olefin-based thermoplastic elastomer, thermoplastic polyurethane, thermoplastic copolyester, styrene block copolymers such as styrene-butadiene-styrene copolymer, styrene-ethylene-butylene-styrene copolymer, styrene-ethylene-propylene-styrene copolymer, styrene-ethylene-ethylene-propylene-styrene copolymer, poly(methyl methacrylate-co-butadiene-co-styrene), thermoplastic copolyamide and mixtures thereof.

14. Edge strip according to any one of the preceding claims, characterized in that the functional layer is connected to the structural layer by coextrusion.

15. Edge strip according to any one of the preceding claims, characterized in that the functional layer is connected to the structural layer by post-coating, post-coextrusion, lamination or hot coating.

16. Edge strip according to any one of the preceding claims, characterized in that an adhesion promoter layer is arranged between the functional layer and the structural layer.

17. Method for producing an edge strip, in particular for pieces of furniture, comprising a structural layer and at least one functional layer for fastening the edge strip to a narrow side of a workpiece, in particular a piece of furniture, said functional layer being connected to the structural layer and containing a polypropylene homopolymer and a polyethylene homopolymer, and said method comprising
a. forming, in particular extruding, the at least one functional layer containing the polypropylene homopolymer and the polyethylene homopolymer,
b. forming, in particular extruding, the structural layer, and
c. connecting the functional layer to the structural layer,
wherein the polypropylene homopolymer has a melt flow index of 150 g/10 min or more, measured at 230° C. with a weight of 2.16 kg according to DIN EN ISO 1133-1, in particular DIN EN ISO 1133-1:2021-03.

18. Method according to claim 17, characterized in that the functional layer is defined by at least one further feature of claims 2 to 12, and/or in that the structural layer is defined by at least one feature of claim 13, and/or in that the method is a method for producing an edge strip according to any one of claims 1 to 16.

19. Method according to any one of claims 17 and 18, characterized in that the functional layer is connected to the structural layer by coextrusion or in that the functional layer is connected to the structural layer by post-coating, post-coextrusion, lamination or hot coating.

20. Method according to any one of claims 17 to 19, characterized in that an adhesion promoter layer is provided between the structural layer and the functional layer, in particular in that an adhesion promoter layer is applied to the structural layer and/or to the functional layer, preferably by coextrusion, extrusion, in particular post-coextrusion, or by application of an adhesion-promoter-containing liquid.

21. Method for fastening an edge strip according to any one of claims 1 to 16 to the narrow side of a workpiece, in particular a piece of furniture, wherein the functional layer is activated by the effect of at least one of laser radiation, microwave radiation, ultrasound, infrared radiation, plasma and hot air.

22. Use of a functional layer as defined in any one of claims 1 to 12 as a band-shaped hot-melt cement, in particular in the fastening of a strip or a band, in particular a strip or a band made of a material as described in claim 13, to a narrow side of a workpiece, in particular a piece of furniture.

23. Workpiece, in particular piece of furniture, comprising an edge strip according to any one of claims 1 to 16.

24. Band-shaped hot-melt cement for fastening a strip or a band to a narrow side of a workpiece, in particular a piece of furniture, characterized in that the hot-melt cement contains a polypropylene homopolymer and a polyethylene homopolymer, the polypropylene homopolymer having a melt flow index of 150 g/10 min or more, measured at 230° C. with a weight of 2.16 kg according to DIN EN ISO 1133-1, in particular DIN EN ISO 1133-1:2021-03.

25. Hot-melt cement according to claim 24, the hot-melt cement being further characterized by at least one feature of the functional layer according to any one of claims 2 to 12.
